(19) United States
(12) Patent Application Publication
(10) Pub. No.: US 2022/0338430 A1
(43) Pub. Date: Oct. 27, 2022

(54) UNIVERSAL PLANT WATERING APPARATUS

(71) Applicant: Yael ROZENBERG, Tel Aviv (IL)

(72) Inventor: Yael ROZENBERG, Tel Aviv (IL)

(21) Appl. No.: 17/624,232

(22) PCT Filed: Jul. 5, 2020
(86) PCT No.: PCT/IL2020/050747

§ 371 Date: Dec. 30, 2021

(30) Foreign Application Priority Data
Jul. 4, 2019 (IL) 267858

(51) Int. Cl. A01G 27/06; A01G 27/00

(52) U.S. Cl. CPC A01G 27/06; A01G 27/003

(57) ABSTRACT

The application relates to a plant watering apparatus comprising an outer pipe, an inner pipe, a water tank and a base, wherein said outer pipe having a lower end and an upper end, and wherein said inner pipe having a lower end and an upper end, and wherein said inner pipe is inserted in said outer pipe, and wherein said lower end of said inner pipe is designed to allow water to be poured from said inner pipe to the proximal vicinity of said lower end of said inner pipe, and wherein said lower end of said outer pipe is in vicinity of said base and designed to allow water to be moved from said proximal vicinity of said inner pipe to the soil outside said outer pipe, and wherein said water tank is connected to said upper end of said inner pipe in a watertight and airtight manner. And wherein said plant watering apparatus is designed to be inserted into soil, and wherein said upper end of said outer pipe is designed to be at least at said soil surface to allow free airflow between said upper and said lower ends of said outer pipe.

### FIELD OF THE INVENTION

The field of the present invention is plants irrigation and more specifically planters and plant pots (plant containers) irrigating system. Even more specifically an independent universal plant pot/planter irrigating system.

### BACKGROUND

### Description of Prior Art

Drip irrigation has been used for thousands of years. Ancient people knew that they had to supply water to their crops, and they did so by any means possible. They eventually figured out how to bury clay pots near the plants. Ever Since a lot of irrigating and watering systems has evolved, quite numerous of each are aimed at self-watering systems and dripping irrigation systems.

To those skilled in the art, it is understood that a method for self-irrigation that allows water to be supplied inside the soil, at roots level of the plant, as well as with appropriate quantities i.e. not over floating not under wetting, is desired. It is further understood that a method that can be controlled is desired. Such control aims at determining the amount of water consumed by the system, and accordingly the water supply for the system.

Many attempts have been made in the prior art to provide such irrigating systems. Here are some instances:

U.S. Pat. No. 4,745,706A—A plant watering and feeding support combines a gravity feed watering and fertilizing system along with the holding features of a stake. The support, which may be driven into the ground next to a plant, comprises a hollow tube having a plurality of holes in a bottom portion with such holes permitting a slow delivery of water and fertilizer into the soil. Additionally, the plant is attachable to the support by snap-on plastic straps, and the straps are mounted in grooves which permit their movement upwardly along the stake as the associated plant grows.

U.S. Pat. No. 5,546,700 (A)—describes a fluid level control for a container having a space to which fluid is supplied from a reservoir. The specifically disclosed application for the invention is a water level controlled planter. The fluid level control system includes a compartment in which fluid level is controlled. One or more removable plugs can be inserted in two or more fluid level control holes at different levels in the compartment. An air lock prevents air from flowing into the reservoir when the water level within the compartment is above the fluid level control hole. When the water level in the compartment falls below the uppermost open fluid level control hole, air is permitted to enter the reservoir and water may flow through the fluid level control hole into the compartment.

US2014007501 (A1)—discloses a self-watering planter comprises a wick, reservoir, wick-housing running between the soil/soil substitute and the reservoir, and a tight fitting cap to maintain a vacuum seal within the reservoir. The water or liquid mixture is maintained at a constant level across the wick by the vacuum that is created. This prevents water from flowing upwards into the soil when the soil is already wet. Liquid is only drawn from the wick by osmosis when the soil is dry. Even as the water level in the reservoir drops, the water level across the wick continues to remain level until the reservoir is nearly empty, allowing the soil constant access to water until the reservoir needs refilling.

U.S. Pat. No. 3,758,987 (A) describes an automatic plant watering device responsive to the plant's need for water is disclosed. The new watering device includes a porous sensing element that is inserted into the soil and responds to the moisture content of the soil to control the supply of water from a substantially airtight enclosure. The porous element constitutes an air valve. When the soil is relatively dry, air flows through the porous element, and water is released from the enclosure to the soil. When the soil is wet, air cannot pass through the sensing element and the flow of water is automatically shut off. The invention is also directed, in part, to a novel sensing and control device for incorporation in an automatic plant watering device or system.

U.S. Pat. No. 4,885,870 discloses a plant container has a pot (8) surrounded by a water reservoir (15) above a tray (12). When the water level in the tray drops, air can pass up through a vent pipe (18) to relieve a partial vacuum in the reservoir and allow water to drip through an outlet aperture (27) into the dish. To avoid water being forced out of the top of the tube (18) by air bubbles, a constriction is provided in a plug 20 at the bottom of the vent pipe (18) to restrict the size of the air bubbles entering the pipe.

All prior art solutions for independent watering systems, require a built-in water reservoir or otherwise a dedicated container or plant pot. Some of them rely on sensors or other measurements, to determine irrigation speed and float.

There is still a need in the art for an irrigating apparatus, designed for lower watering to be consumed by Capillary action, that supplied with accordance to actual consumption, and doesn't require a dedicated reservoir or tank to be built in the plant container or to be put next to it or in its vicinity.

### SUMMARY OF THE INVENTION

It is, therefore, an object of the present invention to provide for an economic, universal plant pot irrigating apparatus that is based on underground irrigation with accordance to actual soil moisture and water consumption.

It is a further object of the present invention to provide for a universal plant pot watering apparatus that is easy to manufacture, and easy to use and maintain, further characterized with a detachable water tank that can be filled without a nearby plumbing or power supplies, (could be of various quantities), and capable of containing fertilizing substances (The tank is of a known size and can be rinsed and cleaned).

It is yet another object of the present invention to provide a watering apparatus, capable of adapting to actual water consumption, regardless of climate zone and water quality. i.e. capable of slow and rapid irrigation rates, and is not subject to blockage and other disorders relating to hard water.

The invention disclosed herein relates to a watering apparatus that could be used independently with any plant growing environment. It is better designed for plants in a separate container such as, but not limited to, a planter or plant pot, yet those skilled in the art would be able to adapt it for larger scale soil or dirt environments that consist a platform for plants.

The watering apparatus according to the present invention is designed to allow drip irrigation for soil or dirt, in an independent manner of maintaining a constant level of water in said dirt or soil.

The watering apparatus according to the present invention is designed to be of a universal character, thus it could be fitted in any plant container or soil, or in the vicinity of any plant. Therefore, the watering apparatus could be fitted to any existing container or in the vicinity of any plant. The watering apparatus doesn't require a dedicated water reservoir to be fit in or aside of the plant container, therefore could be fitted into any existing plant container.

The watering apparatus according to the present invention allow subsurface irrigation, i.e. the watering of a plant below the upper level of the dirt or ground, irrigation that is preferred and favoured for many reasons, known in the art.

The watering apparatus according to the present invention comprises two pipes. An outer pipe and an inner pipe. It is further designed to be connected to the water supplying tank, preferably in the form of a bottle. Said tank could be either a dedicated container or any other universal bottle or other. Said tank is detachable and allows replacing or filling it.

### BRIEF DESCRIPTION OF THE DRAWING

FIG. 1: A watering apparatus according to the present invention fitted in a planter.

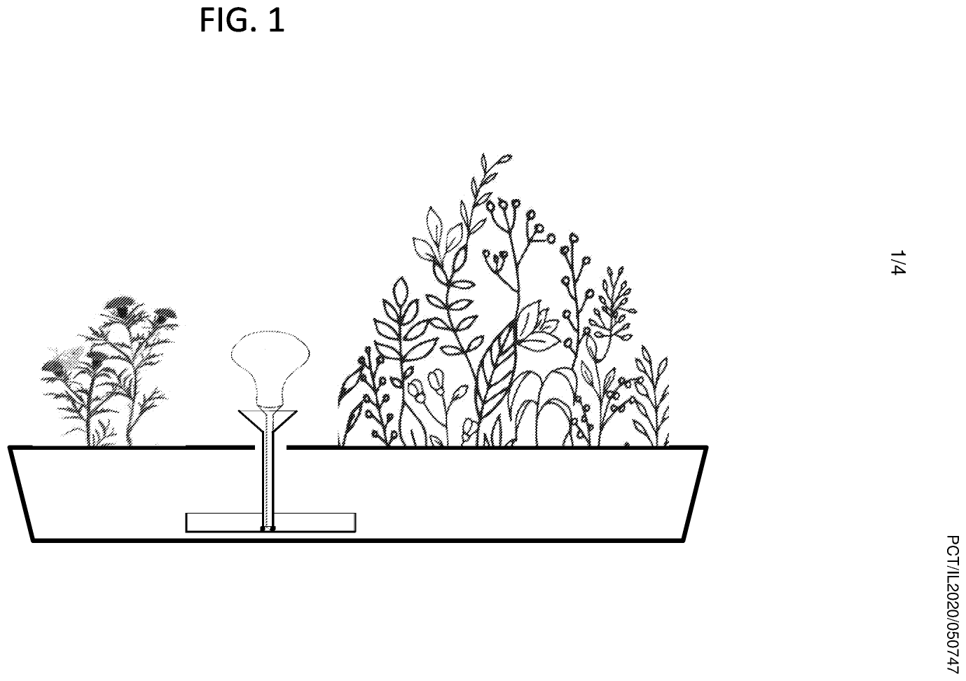

FIG. 2: Structure of a watering apparatus according to some embodiments of the present invention.

FIG. 3: Structure of a watering apparatus according to other embodiment of the present invention.

FIG. 4: Depict horizontal cross-section of the watering apparatus shown in FIG. 2.

### A DETAILED DESCRIPTION OF THE EMBODIMENTS

It will be understood to those skilled in the art that the watering apparatus of the present invention designed to allow irrigation dripping only when a gap between the lower end of the apparatus and the surface beneath is not filled with water, thus allowing air to enter the inner pipe up to the water tank, and water poured from the tank, until said gap and the vicinity of the lower end of the apparatus are water filled or soaked again. When said vicinity is filled with water the atmospheric pressure on said water, is stopping the water for further spilling out of the apparatus.

This is designed in accordance with the same principle used by Italian scientist Torricelli in his barometer experiment. The air or atmosphere pressure apply direct force on the surface of the water proximal to said lower end of the apparatus, through the gap formed between said inner pipe that is sealed with the tank connected to it. And the outer pipe. Said gap is open to the air, therefore the air in the atmosphere could apply its gravitational air on it, blocking further dripping or otherwise spilling out the water.

Therefore, it is understood that the watering apparatus according to the present invention could be used in a wide range of measurements, and with any quantity of water.

The only two limitations, concerning the measurements of the apparatus of the present invention, are a) The apparatus according to the present invention could not exceed the length (height) of 10.2 meters, and b) Said tank should be held by said apparatus when fitted in soil, dirt or the ground.

It will be emphasized that said height is to be measured from the base of the watering apparatus, to the top level of the water in the tank or the pipe itself. Said height is not affected by the angle between the apparatus and the ground and based on the calculation of the balance between the force applied by the mass of the water in the inner pipe, to the force of the air in the gap between two pipes one the water at the lower end of said gap (atmospheric pressure):

The calculation is derived from the knowledge regarded mercury pressure (mmHg) which is a unit used in barometers. One mmHg is the pressure exerted by a 1 mm vertical column of mercury (Hg) at 0 degree Celsius. One mmHg is virtually equal to 1 torr, which is defined as 1/760 of 1 atmosphere (atm) pressure (i.e., 1 atm=760 mmHg). According to this calculation, when we use a watering apparatus, filled with water, we could have a much taller (vertically longer) pipe that still keeps water inside it, since water is lighter than mercury, and thus apply smaller force per volume. The force that applied by the weight of cubic meter of water is [9.8]. Hence, the water is lighter than the mercury at about 133.7/9.81=13.6. Therefore, for water will be required pipe length of: 13.6*760 [mm]=1034 [cm]=10.34 [m]

It will be understood that most uses of the apparatus according to the present invention would be of much smaller height, therefore it ensures that water from the apparatus will be released only when water will be consumed by the plant or otherwise from the vicinity of the lower end of the apparatus, allowing air inside the system. When air is allowed to enter the inner pipe, due to the consumption of water from the vicinity of the lower end, the atmospheric pressure is not stopping the water from flowing down by applying pressure on surrounding water, but rather forcing them down, until the vicinity of the inner pipe is airtight again.

In some embodiment of the present invention, the apparatus is designed to be inserted into any container: planter plant pot or other. The lower part of the apparatus is designed to be proximal to the bottom of said container and the upper end is designed to be erected above the soil level of said container.

In some embodiment of the present invention, the water is supplied to the apparatus by a tank designed to be fit to the upper end of the inner pipe. Such connection needs to allow water to stream through the inner pipe, and not allow air to be entered in the system. Said tank could be a dedicated bottle or any other bottle. In some embodiments said connection is designed to feet as a universal water lid, and in other embodiments, there is a lid adaptor for enabling different kinds of bottles to be used as said tank.

In yet other embodiments the water tank is a dedicated bottle designed to fit said connection to the upper end of said inner pipe.

It is understood, that although a water tank is favourable, the apparatus could be operated without a tank based on the water content of said inner pipe itself, as long as the upper end of said inner pipe is sealed and air could not enter the system, Such embodiment is possible for example when said inner pipe is long and wide enough to contain a sufficient amount of water.

The outer pipe of the apparatus is designed to be inserted in a container, wherein the lower end of said outer pipe is proximal to the bottom of the container and upper end of said outer pipe is at least at the level of the soil filled in said container. In a manner that allows a column of air in the gap between said outer pipe and said inner pipe, It is understood therefore that both pipes could be of different length as long as all said principles are kept.

In a preferred embodiment of the apparatus, the outer pipe has a cone-shaped head at its top end. Said head is designed for easy insertion of the inner pipe into the outer pipe, and further allows the collection of spilt water to the lower part when a bottle is held upside down and being connected to the inner pipe.

In some embodiments of the present invention, the lower part of the outer pipe has a wider base. Said base could be of conical shape or other shape and could provide better stability and balance of the entire apparatus, as well as a less condensed soil in the vicinity of the lower end of the inner pipe, resulting in better functioning of the water supply.

Said base has holes or openings in it to allow water from the system to stream into the container.

In other embodiments of the present invention, the lower part of the outer pipe is attached to a flat saucer-like base. Said base has a bottom and could have a side wall. When placed in a container said saucer-like base is filled with soil as the rest of the container and is used to enable better stability and balance of the system, as well as allowing the control of the gap of the inner pipe lower end.

When said apparatus is used in a manner that it doesn't put on the bottom of a container, and having a substantially height of soil under it (e.g. in a higher container or in the ground) the saucer-like base must have sidewalls to maintain a sufficient amount of water to block air from entering the inner pipe, and cause the water to spill out.

The lower part of the inner pipe, according to the present invention must have a gap to allow water inside said pipe to touch the water outside said lower part, when not pouring water, and to pour water when air comes in.

Said gap could be achieved by placing the lower end of said inner pipe slightly higher than the lower end of the outer pipe, by cutting the lower end of the inner pipe in a diagonal manner or by having holes, or another shape end.

The system according to the present invention is designed to allow water to be supplied to the container until the gap between said inner pipe and the bottom of the container is filled with water. When the container consumes more water, either because of plant usage or other (vapourising, etc.) a Capillary action of the soil draw the water from the vicinity of the lower end of said inner pipe, causing air to enter the system, and allows water to drop down until filled with water again.

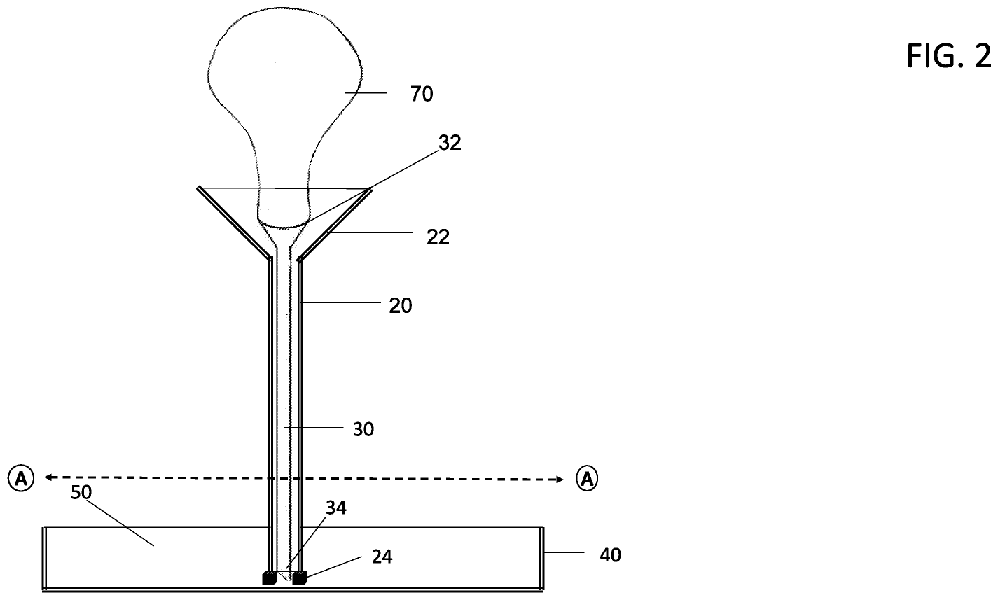

Attention is drawn now to FIG. 2. A water tank (70) is connected to the watering apparatus, at a connection point (32), said connection point must prevent any air from entering the system. The water tank could be a dedicated tank, or any other bottle or container, providing that it is connectable and can prevent any air from the system. In other embodiments, the tank could be an integral part of the system, providing a filling opening at its top. In those embodiments the filling opening must have a closing element, to prevent any air from entering the system both at the process of refill and during operation.

The tank is connected (32) to the inner pipe (30) which is designed for the water to flow through for irrigation. The lower end of said inner pipe (34) is uneven rim, to allow part of it to touch the bottom of the base (40) while allowing a gap through which water still can flow. Said lower end of the inner pipe, could be of any shape or design that allows water to flow through it, whether parts of its perimeter touch the bottom or not.

The outer pipe (20) should allow for air to move freely from its top to its bottom, for allowing atmospheric pressure on the water in the vicinity of the inner pipe lower end, preventing the water in the system from spill out. And flowing inside the inner pipe when water is consumed therein. Said outer pipe (20) could have a head (22) to collect spilt water that might spill out when flipping over the water tank while connecting it to the inner pipe (200 connection (22). In other embodiments the outer pipe has no head or other shaped head providing that its upper end is proximal to the upper surface of the soil in the planter, plant pot or container, preferably above.

The system is connected at its lower part to a saucer-like base (40) such base could be round, or have any other shape. The base (40) should have a bottom, and could optionally have a sidewall. In preferred embodiments, the system is attached to the base which ensures the correct openings (24/34) for watering is kept between both pipes and the bottom. The base could also provide for a better balance and stability for carrying the weight of the water tank (70). In some embodiments, the base (40) could be an integral part of the plant container, and the system could be either connected to it or just put on it. In these embodiments, the bottom should either be with no drainage holes or have an outer base for collecting drainage. Said outer base should have a sidewall of at least the same height of the gap between both pipes (24/34) and the bottom of the base.

The saucer or other shaped base is designed the soil (50) of the plant container be on it.

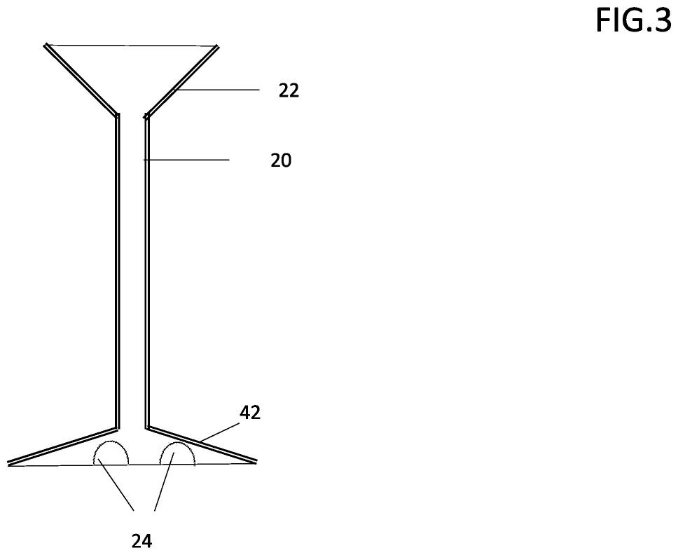

Attention is drawn now to FIG. 3, which depict a configuration of the outer pipe (20) with accordance to some embodiments of the present invention.

The outer pipe (20) is having a head (22) as described before, and having a cone-shaped base (42). Said cone shape base is having holes (24) allowing water to flow from the cavity of the lower end of the system to the soil of the plant container. In this embodiment, the inner pipe could be either with holes or other gaps or has its full perimeter above the bottom of the plant container.

It will be understood that the inner pipe and the outer pipe doesn't need to be connected, therefore it is possible to pull the inner pipe out while the outer pipe remains intact. In other embodiments the pipes could be connected in any acceptable manner along their lengths, providing that a free air pass is allowed between the top end of the outer pipe (20) and the lower end of the inner pipe (30).

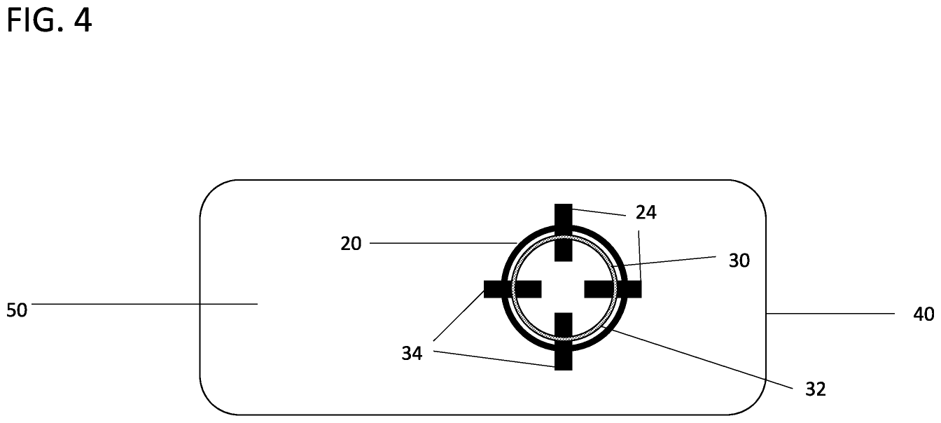

Attention is drawn now to FIG. 4, which depict a cross-section or upper view, of the embodiment of FIG. 2. The saucer-shaped base (40) is of rectangular shape but could be at any shape and size providing for a better balance and depends on the side and shape of the plant container. The holes in the outer pipe (24) are aligned with same size holes in the inner pipe (34) yet it is emphasized again that the inner pipe could be fully or partially not in touch with the bottom of the base. the inner pipe is preferably inserted into the outer pipe yet in other embodiments it could be connected to the outer pipe at any point, optionally above said holes (24/34). The base (40) could be an integral part of the system or the bottom of the plant container, as long as the overall lower proximity of the apparatus is allowing water to be collected in the vicinity of the lower end up to the height of the inner pipe gap or hole.

It will therefore be understood that if the plant container has drain holes in it, the watering device should have a base surface with sidewalls, or alternatively, if uses the container bottom as base, require an outer water collecting plate to be put under the container.

The term ‘method’, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Throughout this disclosure, a numerical value of a parameter, feature, characteristic, object, or dimension, may be stated or described in terms of a numerical range format. Such a numerical range format, as used herein, illustrates the implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably.

The term ‘about’, in some embodiments, refers to ±30% of the stated numerical value. In further embodiments, the term refers to ±20% of the stated numerical value. In yet further embodiments, the term refers to ±10% of the stated numerical value.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment, may also be illustratively described and presented in the context or format of a plurality of separate embodiments.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A plant watering apparatus comprising;
an outer pipe, an inner pipe, a water tank and a base, wherein
said outer pipe having a lower end and an upper end, and wherein
said inner pipe having a lower end and an upper end, and wherein
said inner pipe is inserted in said outer pipe, and wherein
said lower end of said inner pipe is designed to allow’ water to be poured from said inner pipe to the proximal vicinity of said lower end of said inner pipe, and wherein
said lower end of said outer pipe is in vicinity of said base and designed to allow water to be moved from said proximal vicinity of said inner pipe to the soil outside said outer pipe, and wherein
said water tank is connected to said upper end of said inner pipe in a watertight and airtight manner. And wherein
said plant watering apparatus is designed to be inserted into soil, and wherein
said upper end of said outer pipe is designed to be at least at said soil surface to allow free airflow between said upper and said lower ends of said outer pipe.

2. A plant watering apparatus as in claim 1 wherein said base comprising a top edge and bottom edge, wherein said top edge is connected to said lower end of said outer pipe, and said bottom edge is designed to rest on a plant container bottom, and wherein
said base has at least one opening, allowing for water to be absorbed by said plant container soil.

3. A plant watering device of claim 1 wherein said base is
A flat surfaces connected to said apparatus and designed to be put on the bottom of a plant container.

4. A plant watering device of claim 3 wherein said base is further comprising a sidewall defining said surface perimeter, and wherein said sidewall height is at least as high as the highest point of said inner pipe lower end.

5. A plant watering device of claim 1 wherein said base is the bottom of a plant container, and wherein said outer pipe is connected or coupled with said base.

6. A plant watering device of claim 1 wherein said water tank is permanently connected to said inner pipe.

7. A plant watering device of claim 1 wherein said water tank is detachable from said upper end of said inner pipe.

8. A plant watering device of claim 7 wherein said water tank is further comprising a means designed to prevent water to be spilt from the tank or air to enter the tank in the process of reattaching said tank to said inner pipe.

9. A plant watering device of claim 1 wherein said inner pipe is designed to be extracted and reinserted to position.

10. A plant watering device of claim 1 wherein said inner pipe is fixed to outer pipe, base or any combination thereof.

11. A plant watering device of claim 1, wherein said water tank is any non-dedicated bottle.

12. A plant watering device of claim 11, further comprising an adapter to allow different water tanks to be connected to said upper end of said inner pipe.
